(19) United States
(12) Patent Application Publication
(10) Pub. No.: US 2007/0150744 A1
(43) Pub. Date: Jun. 28, 2007

(54) Dual authentications utilizing secure token chains

(76) Inventors: Siu Lung Cheng, Hong Kong (CN); Ha Yin Wong, Hong Kong (CN); Kam Hing Lau, Hong Kong (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/317,944

(22) Filed: Dec. 22, 2005

(51) Int. Cl. H04L 9/00; H04K 1/00

(52) U.S. Cl. 713/185; 713/172; 713/181; 713/176; 713/183; 713/175; 713/173; 713/156; 713/158

(57) ABSTRACT

Embodiments include a method and a system of authenticating a client when the client logs in a servicing. According to one embodiment, a first authentication code and a second authentication code is submitted from the client to the servicing server. The second authentication code includes a secure token of a reversal secure token chain with a hash function and an index of the secure token in the reversal secure token chain. The first authentication code is then verified at the servicing server. The secure token is also verified at the servicing server by comparing a hash value of the secure token with a previously acquired secure token or a root of the reversal secure token chain. If the first authentication code and the second authentication code are associated, the login is confirmed.

### FIELD OF THE INVENTION

The present invention relates to an improved data processing system. More particularly, the present invention relates to a method and system for authentication within a data processing system.

### BACKGROUND OF THE INVENTION

Public key infrastructure (PKI) refers to a technology defining an infrastructure that implements and delivers pervasive security structures using public key cryptography concepts and techniques. The proliferation of PKI services has mushroomed in light of the demand of users to exchange secure data or verify users and/or associated data over interconnected networks, such as the Internet.

Public key cryptography has been used to provide encryption and signature functions. In a PKI, a user has a key pair of private key and public key, where private key is kept secretly to the user and the public key is known to the public. Anyone can use the user's public key to encrypt a message to the user, such that only the user can decrypt the message using his or her private key. On the other hand, the user can sign a digital signature on a message using his or her private key, so that other people can use his or her public key to verify the validity of the digital signature.

As the key pair of private key and public key is associated to the user's identity, it requires an organization to certify the ownership of the keys of the user. This organization is generally known as the certificate authority (CA).

The existing PKI system faces two main challenges. The first challenge is that the computation power of the encryption and signature process is very high. The second challenge is that the process for a user to acquire a certificate from CA is too complicated. The process is an offline manual process requiring high level of technical knowledge. Despite, these challenges, PKI remains popular solution. However, a need exists for improved systems to address these challenges.

### SUMMARY OF THE INVENTION

Embodiments include a method and system of authenticating a client when the client logs in a servicing server. In one aspect, a first authentication code and a second authentication code is submitted from the client to the servicing server. The first authentication code can be a password or a pair of login name and password. The second authentication code includes a secure token of a reversal secure token chain with a hash function and an index of the secure token in the reversal secure token chain. The first authentication code is then verified at the servicing server. The secure token is also verified at the servicing server by comparing a hash value of the secure token with a previously acquired secure token or a root of the reversal secure token chain. In particular, the hash value of the secure token is compared with a last acquired secure token if the index of the secure token is greater than one, and the hash value of the secure token is compared with the root of the reversal secure token chain if the index of the secure token is equal to one. Finally, if the first authentication code and the second authentication code are associated, the login is confirmed. The secure tokens of the reversal secure token chain are, in one embodiment, consumed in an ascending order.

In one embodiment, before sending the first authentication code and the second authentication code to the servicing server, a setup stage is involved. The setup stage can include two types of setups. The first type is called “relationship setup,” and the second type is called “chain setup.”

During the relationship setup, a server certificate and a client certificate are acquired by the servicing server and the client, respectively. The relationship setup is conducted once or until one of the client and server certificates is expired or revoked. The client certificate, in one embodiment, includes a name of the servicing server, a name of the client, a public key of the client and an expiration date of the client certificate. The client certificate can also include contact information of the client. The client certificate is signed by a private key of the servicing server.

During the chain setup, the reversal secure token chain with the hash function is created. A commitment is created and submitted to the servicing server. The commitment is verified with a public key of the client at the servicing server. The chain setup is conducted every time a new reversal secure token chain is created at the client.

The reversal secure token chain and the commitment can be created by a user program, which is downloaded from a download server to the client. The commitment, in one embodiment, includes a purpose of the reversal secure token chain, the client certificate, the root of the reversal secure token chain and current date. The commitment can also include a period of time that the reversal secure token chain must be consumed. The commitment is signed by a private of the client.

In another aspect, a secure token of a reversal secure token chain with a hash function and an index of the secure token in the reversal secure token chain are submitted from the client to the servicing server. The secure token at the servicing server is validated by comparing a hash value of the secure token with a previously acquired secure token or a root of the reversal secure token chain. In one embodiment, the hash value of the secure token is compared with a last acquired secure token if the index of the secure token is greater than one, and the hash value of the secure token is compared with the root of the reversal secure token chain if the index of the secure token is equal to one. The secure tokes of the reversal secure token chain are, in one embodiment, consumed in an ascending order.

### BRIEF DESCRIPTION OF THE DRAWINGS

FIG. 1 is a diagram showing a dual authentication mechanism.

FIG. 1a is a flowchart showing the process of authentication of FIG. 1 described above.

FIG. 2 is a diagram showing that the user program and the server program store reversal hashed chains to provide secure authentication capability.

FIG. 3 is a flowchart showing the process of authentication of FIG. 2.

FIG. 4 is a diagram showing a scheme of downloading a user program.

FIG. 5 is a flowchart of an exemplary process for a user to obtain a download code using a mobile phone according to the scheme of FIG. 4.

FIG. 6 is a flowchart of a process for a user to obtain a user program using the download code according to the scheme of FIG. 4.

FIG. 7 is a diagram showing another scheme of downloading a user program and using the user to self-generate the PKI keys.

FIG. 8 is a flowchart of an exemplary process for a user to obtain a download code using a mobile phone according to the scheme of FIG. 7.

FIG. 9 is a flowchart of a process for a user to obtain a generic user program using the download code according to the scheme of FIG. 7.

### DETAILED DESCRIPTION OF PREFERRED EMBODIMENTS

Reference is now made in detail to one embodiment of the invention, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the invention is not limited to the precise embodiments described below and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims.

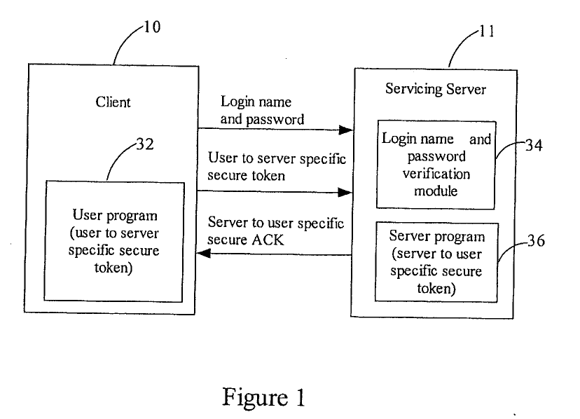

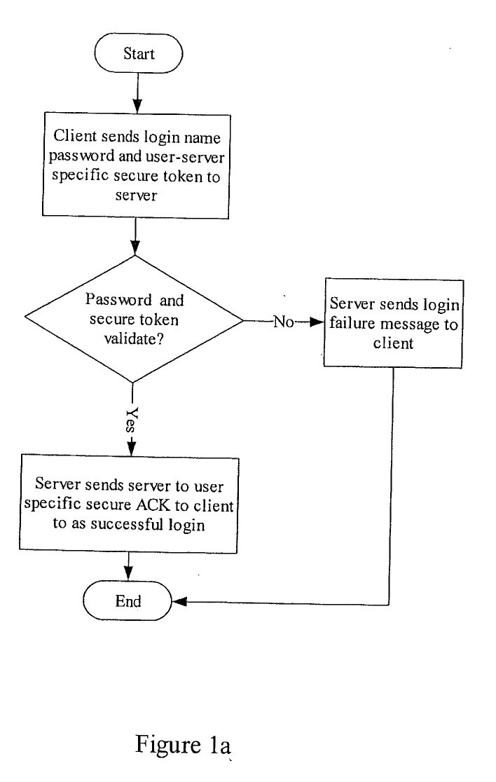

FIG. 1 is a diagram showing a dual authentication mechanism. The relationship between a servicing server 11 and a client 10 is shown in the diagram. The client 10 can use both login name/password and a secure token to authenticate itself. The secure token can be a series of characters and/or numbers generated according to certain security algorithm. If an adversary party obtains either one of the two credentials, the party will not be able to gain access to the servicing server 11.

The scheme in connection with FIG. 1 has a mechanism for the user to gain and install a unique user program 32, which contains a specific user to server secure token module, at the client 10. As used herein, the “user program” refers to an application program running at the client side. The user program 32 generally provides a user interface for the user to remotely log on to a servicing server 11, such as a server providing banking services or a server providing online shopping services. The user program 32 also generates and verifies the secure tokens for interacting with the servicing server 11. The user program runs at the client side 10 for initial setup before it can be used for authentication. During the setup process, the client 10 and the servicing server 11 have identity and credential information exchanged, so that user using the same client can be authenticated based on the exchanged information. The servicing server 11 includes a login name and password verification module 34 and a server program 36, which contains a server to user specific secure token. As used herein, the “server program” refers to an application program running at the server side. The server program, in one embodiment, listens to the request from the client side, authenticates clients, generates and verifies secure token for interacting with the client 10. The servicing server 11 then sends a specific secure ACK to the client 10 to indicate an authentication result. The specific secure ACK contains a secure token generated by the servicing server 11 and can be verified by the user program 32. The user program 32 is able to verify the specific secure ACK because there was identity and credential information exchanged between the user program 32 and the servicing server 11 during the installation of the user program 32. FIG. 1a is a flowchart showing the process of authentication of FIG. 1 described above.

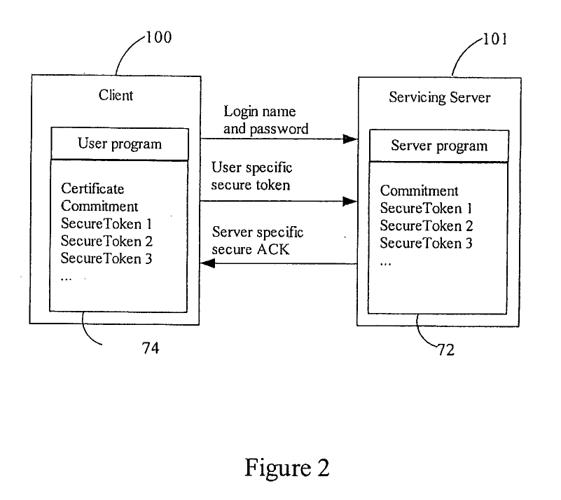

Referring now to FIG. 2, a diagram of FIG. 2 illustrates one embodiment of a user program 74 and a server program 72 that store reversal hashed chains to provide secure authentication capability. A reversal hashed chain is a sequence of tokens. Each token in the chain is derived from the previous token in the sequence. The tokens in the sequence can be used as secure tokens when they are consumed in a reserve order. The relationship between a servicing server 101 and a client 100 is shown in the diagram. The servicing server 101 includes the server program 72, while the client 100 includes the user program 74.

In a secure token chain ω₀, ω₁, ω₂, ωₙ, each secure token is assigned with certain meaning, e.g., each token represent a coupon for redeeming something. The secure tokens can also have different meanings. For example, possession of a secure token means having right to access a system. The secure token chain is created in reverse order by selecting the last secure token ωₙ at random and then computing:
ωᵢ=h(ωᵢ₊₁)

where i=n−1, n−2, . . . , 0; h(·) is a cryptographically strong hash function such as MD5 or SHA; and ω₀ is the root of the secure token chain.

The cryptographically strong hash function is a transformation that takes an input m and returns a fixed size string called the hash value ν, that is ν=h(m). The hash function used in cryptography has, in one embodiment, the properties of one-wayness and collision-free.

A hash function is characterized by a property of one-wayness because it is hard to invert, e.g., when giving a hash value ν, it is computationally infeasible to find a value m such that ν=h(m). A hash function is characterized as being collision-free, e.g., when giving a value x, it is computationally infeasible to find a value y not equal to x such that h(x) =h(y).

In one embodiment, before the servicing server uses a secure token to identify the client, a setup stage is involved. In the illustrated embodiment, the setup stage includes two types of setups. The first type is called “relationship setup,” and the second type is called “chain setup.”

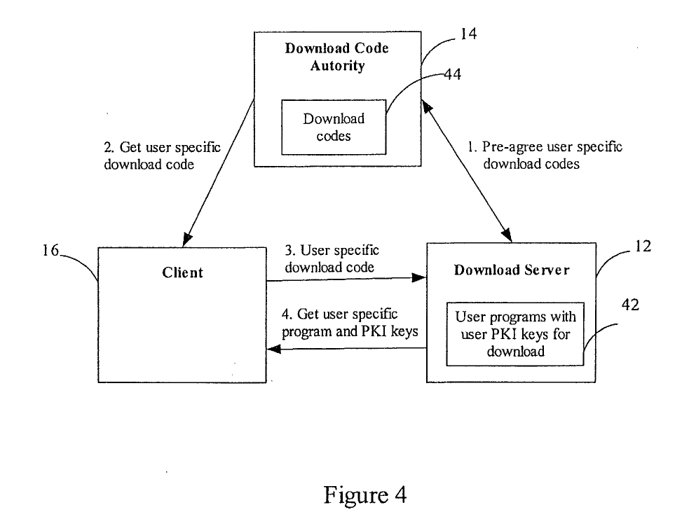

The relationship setup is about acquiring two PKI certificates by both the servicing server and the client, respectively. For the servicing server, a server certificate is issued by a public CA, so that anybody can verify the identity of someone who claims to be the owner of the server. For the client, a client certificate specifically for use with the secure tokens is issued by the servicing server, which is a party that the client can trust. Before the servicing server issues the client certificate to the client, it confirms that a key pair is generated and distributed properly such that the client stores the private key from the key pair and the servicing server keeps the corresponding public key. Different ways for this key distribution process are associated with methods of distributing the client program, which will be discussed in FIGS. 4 to 9.

After the relationship setup is finished, the client gets the client certificate issued by the servicing server. In one embodiment, the client certificate C_{c} can have the form:
C_{c}={s, c, PK_{c}, E, I_{c}}_{SKs}

The client certificate C_{c} is specifically for the client c and is issued by the servicing server s. The certificate C_{c} contains, in one embodiment, the public key of the client PK_{c} and the expiration date E. It is signed by a secret key (private key) SKₛ of the servicing server. The client certificate C_{c} can also contain other information I_{c}, such as the client's contact information, if necessary.

Preferably, the relationship setup is conducted once only or until one of the client and server certificates is expired or revoked.

The chain setup is conducted every time a new reversal secure token chain is created at the user program. In one embodiment, a commitment M is created for a new chain by the user program of the client:
M={P, C_{c}, ω₀, D, I_{M}}_{SKc}

As used herein, the commitment refers to a collection of trustable information related to the corresponding token chain. The commitment M contains the purpose P of the corresponding reversal token chain, the client certificate C_{c}, the root token ω₀ and the current date D. It is signed by a secret key (private key) SK_{c} of the client. The commitment can also contain other information I_{M}, such as the period of time that the chain must be consumed, if necessary.

The commitment is sent to the server during the chain setup stage. When the servicing server receives a commitment, it verifies the commitment with the client's public key. The information in the commitment can then be used for verifying the secure token of the corresponding chain from the client in the future.

After the two setups are finished, the client can send a secure token from the reversal secure chain to the servicing server at anytime to request certain services. The secure tokens are consumed in an ascending order of the index, which is from 1 to n. A message P is sent from the client to the servicing server. The message P contains a secure token ωᵢ and its index i:
P=(ωᵢ, i)

To verify whether the secure token sent by the client is valid, the servicing server computes h(ωᵢ) and check the result with its previously acquired secure token ωᵢ₋₁. The server keeps its previously acquired secure tokens so that the verification can be conducted. If the index i is 1, the verification will be conducted against ω₀ which is found in commitment M.

In one embodiment, an application may need the client to verify whether the acknowledgement of the servicing server is valid. This can be achieved by taking the procedures described above with the role of the servicing server and client reversed. Accordingly, a reversal secure token chain is generated by the servicing server, and the client holds the commitment from the servicing server. The servicing server sends an acknowledgement message to the client with a secure token attached. The client then verifies the acknowledgement message by validating the secure token attached.

With the procedures described above, because hashing is, in one embodiment, much faster than asymmetric cryptography used in the PKI, the process for the client to redeem certain services from the servicing server is more efficient then using the PKI cryptography, while the communication still depends on the PKI security. The tokens in reversal secure token chain are secured by the PKI with the commitment verification by the regular PKI method.

Suppose a client called John is going to get access to banking services provided by a servicing server Bank. Assume John had obtained a client program with a private key embedded therein. The private key is generated by the Bank, and the Bank knows about the public key corresponding to the private key of John. During the relationship setup, the Bank issues a client certificate C_{c} to John:
C_{c}={Bank, John, 00112233445566778899AA1122334455, 2006/12/31,john@abc.com}{AABBCCDDEEFF0011}

The client certificate C_{c} is specifically for the client John and is issued by the servicing server Bank. The public key of the client John is 00112233445566778899AA1122334455 which is a 128-bit key. The expiration date of the client certificate is Dec. 31, 2006. The optional information contains John's email address. The signature of the client certificate AABBCCDDEEFF0011 is also attached.

John needs to use a secure token to get access to the servicing server Bank. The client John's client program generates a reversal secure token chain with the hash function h(·). If the chain length is 100 and the token length is 8 bytes, the chain looks like this:
{ω₁₀₀=9988776611223344, ω₉₉=8899123456780011, . . . ω₂=341256AABB0987EF, ω₁=01234567AABBCCDD, ω₀=98765432ABCDEF00}

ω₁₀₀ is generated randomly and other tokens are generated by hash function h(·), e.g. ω₉₉=h(9988776611223344)=8899123456780011.

Before the token chain can be used, the commitment for the token chain must be recognized by the Bank. The commitment M to be generated looks like this:
M={Bank Login, {Bank, John, 00112233445566778899AA1122334455, 2006/12/31, john@abc.com}{AABBCCDDEEFF0011}, 98765432ABCDEF00, 2005/11/14, 90 days}{009988776655AABB}

The commitment M contains the purpose Bank Login of the corresponding reversal token chain, the client certificate C_{c}, the root token 98765432ABCDEF00, and current date Dec. 14, 2005. There is extra information indicating that the corresponding reversal token chain must be consumed within 90 days. The signature of the commitment 009988776655AABB is also attached.

Now John can start sending request to the Banking services provided by Bank with the first secure token ω₁. The login message contains the index 1 and the token value 01234567AABBCCDD. Bank will validate this token by finding the hash value from hashing the root token ω₀. The root token ω₀ is only known by John, who generated it, and by Bank, who received the commitment containing the root token sent from John. Therefore, only John and Bank can compute the correct value of ω₁(01234567AABBCCDD). By comparing the value derived from John (01234567AABBCCDD) and Bank (h(ω₀)), respectively, the submitted token ω₁ can be verified. Next time, John will send another login message containing index 2 and ω₂. ω₂ is validated by finding the hash value from ω₁. ω₁ is known by John and the Bank because it is derived from the root token ω₀ that is only known by John and Bank. Therefore, only John and Bank can compute the correct value of ω₂ (341256AABB0987EF). By comparing the value derived from John (341256AABB0987EF) and Bank (h(ω₁)), respectively, the submitted token ω₂ can be verified.

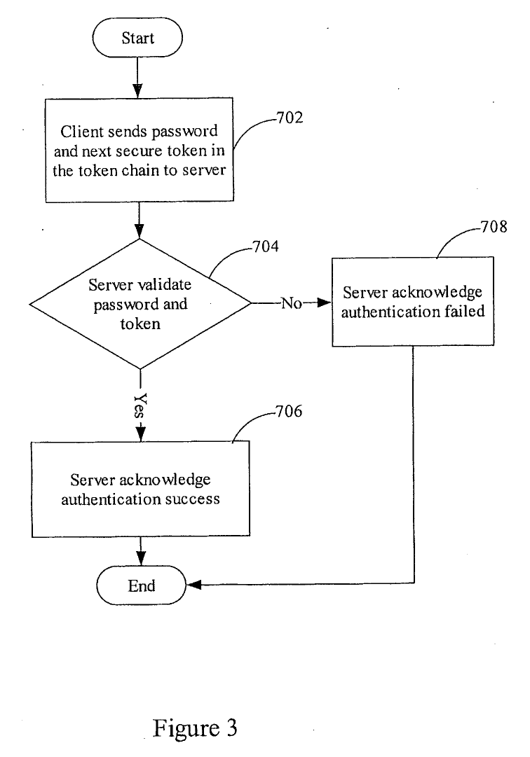

Referring now to FIG. 3, a flowchart showing the process of authentication of FIG. 2 is shown. When a user performs a login, a client sends both the user's first authentication code and second authentication code to a servicing server to authenticate the user (step 702). In the illustrated embodiment, the first authentication code is the user's login name and password pair or just the user's password, while the second authentication code is a secure token. The servicing server then verifies the first authentication code and the validity of the second authentication code and checks if the two are associated (step 704). If the first authentication code and the second authentication code are associated with the same user, the servicing server then responds with a server's secure token to the client to confirm the login (step 706). If the first authentication code and the second authentication code are not associated, the servicing server notifies the client that the login fails (step 708).

The user program and the server program can create secure token chains for specific purposes, e.g., a command of money transfer. When the server program is applied in an e-banking server and the user program is used in an e-banking client, for example, the user program can send a money transfer secure token to the server program to certify such a transaction.

Thus, to address the first challenge (described in the Background section of this patent application) on the efficiency of using PKI protocols, in one embodiment, the schemes in connection with FIGS. 2 and 3 can be used to enhance the efficiency when applying over an authentication process.

FIGS. 4-9 illustrate, two schemes of downloading a user program from a download server to a client that may be employed in various embodiments. The downloaded user program can be used by the client 10 in FIG. 1. The downloaded user program can also be used by the client 100 in FIG. 2, if it contains the reversal secure token chain.

FIG. 4 is a diagram showing a first scheme of downloading a user program from a download server 12 to a client 16. The relationship between a download server 12, a download code authority 14 and a client 16 is shown in the diagram. A user is identified when he or she downloads the user program. Initially, the download server 12 and the download code authority 14 pre-agree on the same user-specific download code. As used herein, the “download server” refers to a server that hosts files downloadable by users; the “download code” refers to a password or code that can be used to access certain files at the download server; and the “download code authority” refers to an entity that generates and distributes the download code. The download server 12 contains user programs with user PKI keys for download 42, and the download code authority 14 contains download codes 44. A user needs his or her download code to download his or her user program.

To download the user program, the user needs to obtain the user-specific download code. The user-specific download code can be obtained from the download code authority 14. The user can make request to obtain the download code by using communication methods such as mailing, telephone conversation, calling an interactive voice response system (IVRS), sending short messaging service (SMS), or other kind of methods that can identify the user's identity by verifying private information or proofing the ownership of certain communication device to the download code authority 14.

The download code authority 14 can send the user-specific download code to the user using communication methods such as mails, SMS or telephone calls, which can correctly identify the user as the right receiver.

For example, the user initially can register his or her mobile phone number with the download code authority 14 through mail or phone over the customer service center of the download code authority 14. When the user requests to get the download code, the download code authority 14 can send the download code to the user's mobile phone using SMS.

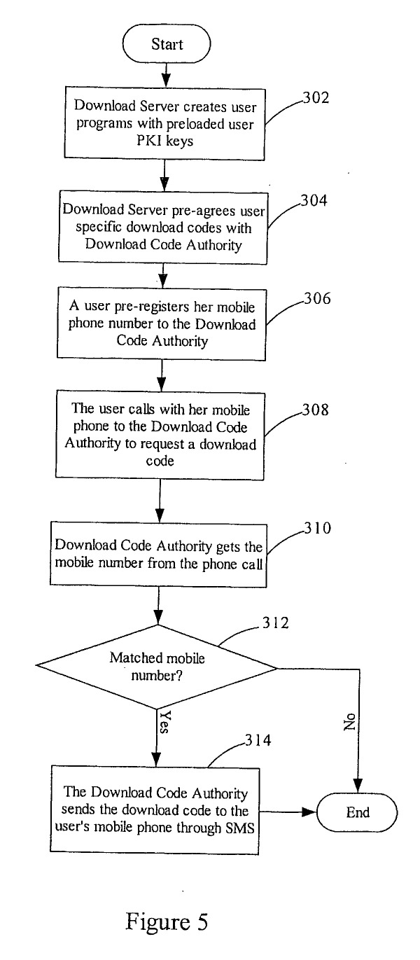

FIG. 5 is a flowchart of an exemplary process for the user to obtain the download code using a mobile phone according to the scheme of FIG. 4. Initially, the download server 12 creates a user program with preloaded user PKI keys as shown in step 302. The download server 12 and the download code authority 14 then pre-agree the user-specific download codes as shown in step 304. The user can use his or her mobile phone. to call the download code authority 14 after pre-registering his or her mobile phone number with the download code authority 14 (step 306 and step 308). The download code authority 14 then check whether the phone number that the user dialed matches the phone number that the user registered after obtaining the mobile phone number from the phone call (step 310 and 312). If the two numbers match, the download code authority 14 will send the download code to the user's mobile phone through SMS. Otherwise, the download code authority 14 will not send the download code to the user.

Although the process for obtaining the download code described herein is in connection with using mobile phone to obtain the download code, it is to be understood that other communication methods can be used to obtain the download code.

Referring back to FIG. 4, after obtaining the download code, the user can submit the download code to the download server 12. The download server 12 can send the corresponding user program with the PKI key embedded in the program to the user. The user can then install the program to the client 16.

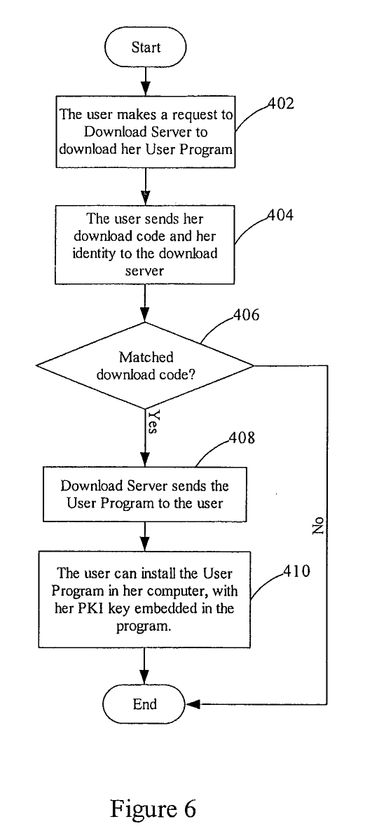

FIG. 6 is a flowchart showing a process for the user to obtain a user program using the download code according to the scheme of FIG. 4. Initially, the user makes a request to the download server 12 to download his or her user program as shown in step 402. The user then submits his or her download code to the download server 12 as shown in step 404. In the meantime, the user's identity can also be sent to the download server 12. The download server checks whether the download code that the user submitted matches the download code that the download server 12 pre-agreed with the download code authority 14 (step 406). If the two download codes match, the download server 12 can send the user program to the user (step 408). Thereafter, the user can install the user program with the PKI key embedded in the program at the client 16 (step 410). Otherwise, the user program is not sent to the user.

In the scheme described in connection with FIG. 4, the system can have multiple pre-agreed user-specific download codes and user-specific secure token programs, so that the user can download and install the program in multiple client systems.

The user to server secure token module in the user program contains a key pair of public key and private key following the PKI. Both the public and private keys are known by the download server 12. The server program contains the key pair of public key and private key following the PKI. The pubic key is known by the user of the client 16, while the private key is kept by the owner of the download server 12. The download code authority 14 can perform the same duty of a CA in a PKI system to handle the revocation and renewal of the public key of the user program. It is to be understood that the download code authority 14 and download server 12 as shown in FIG. 4 and the servicing servers 11 and 101 as shown in FIGS. 1 and 2 can be owned by the same entity or by different entities, depending on the security requirements and arrangements.

The scheme described in connection with FIG. 4 allows an organization to provide a user with a user program preloaded with a key pair of private key and public key for the user. When the user downloads and installs the user program to his or her computer, both PKI capability and the organization's program are ready for the user to use. Using this scheme, the organization knows the private key of the users. This scheme is generally suitable for services where the organization needs to identify the user's identity. Non-repudiation from the user is not required.

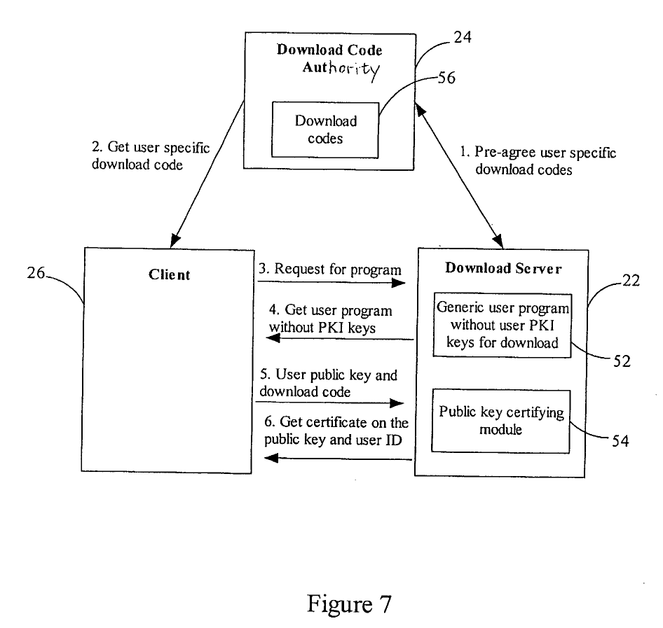

Referring now to FIG. 7, a second scheme of downloading a user program from a download server 22 to a client 26 is shown. This scheme allows the organization to provide a user program to the client 26, such that the user's private key is kept secret by himself or herself. The server program does not know the private key of the user program. This scheme can therefore achieve non-repudiation from the user. Using this scheme, the user obtains a generic user program from the download server 22. As used herein, the term “generic” means that all users obtain the identical copy of the client program, in contrast with the scheme that each user obtains a specific copy of the client program in connection with FIG. 4. The generic user program can automatically generate a PKI key pair for the user and register the public key to the organization. Thereafter, the user can automatically equip with PKI capability and use the organization's service.

The relationship between the download server 22, the download code authority 24 and the client 26 in one embodiment is illustrated in FIG. 7. The download server 22 contains a generic user program without user PKI keys for download 52 and a public key certifying module 54, and the download code authority 24 contains download codes 56. A user needs his or her download code to download the user program. The download server 22 and the download code authority 24 pre-agree on the user-specific download codes.

The user can make request to obtain the download code by using communication methods such as mailing, telephone conversation, calling an interactive voice response system (IVRS), sending short messaging service (SMS), or other kind of methods that can identify the user's identity by verifying private information or proofing the ownership of certain communication device to the download code authority 24.

The download code authority 24 can send the user-specific download code to the user using communication methods such as mails, SMS or telephone calls, which can correctly identify the user as the right receiver.

For example, the user initially registers his or her mobile phone number with the download code authority 24 through mail or phone over the customer service center of the download code authority 24. When the user requests to get the download code, the download code authority 24 can send the download code to the user's mobile phone using SMS.

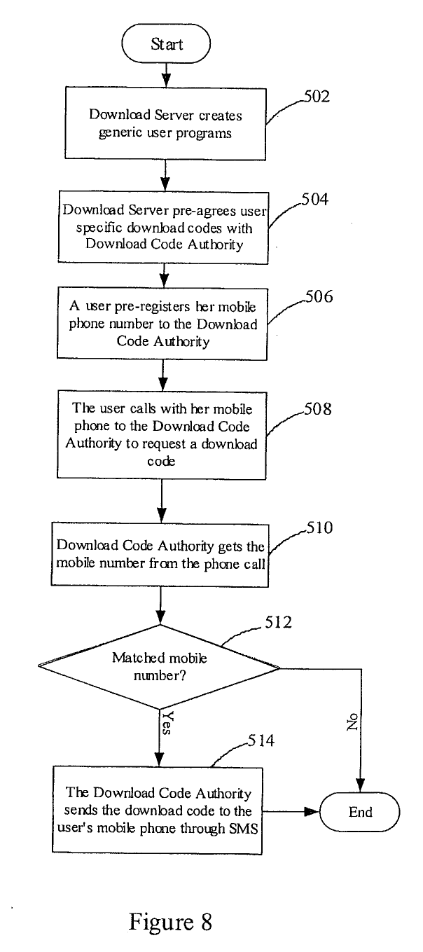

FIG. 8 is a flowchart of an exemplary process for the user to obtain the download code using a mobile phone according to the scheme of FIG. 7. Initially, the download server 22 creates a generic user program as shown in step 502. The download server 22 and the download code authority 24 then pre-agree the user-specific download codes as shown in step 304. The user can use his or her mobile phone to call the download code authority 24 after pre-registering his or her mobile phone number with the download code authority 24 (step 506 and step 508). The download code authority 24 then check whether the phone number that the user dialed matches the phone number that the user registered after obtaining the mobile phone number from the phone call (step 510 and 512). If the two numbers match, the download code authority 24 will send the download code to the user's mobile phone through SMS. Otherwise, the download code authority 24 will not send the download code to the user.

Although the process for obtaining the download code described herein is in connection with using mobile phone to obtain the download code, it is to be understood that other communication methods can be used to obtain the download code.

Referring back to FIG. 7, after obtaining the download code, the user can request for a generic user program from the download server 22. The user program can self-generate a PKI key pair and keep the private key safely. The user can send the corresponding public key together with the download code obtained in the previous step to the server program. The server program can verify the download against the user ID and then certify the received public key and user ID using the public key certifying module.

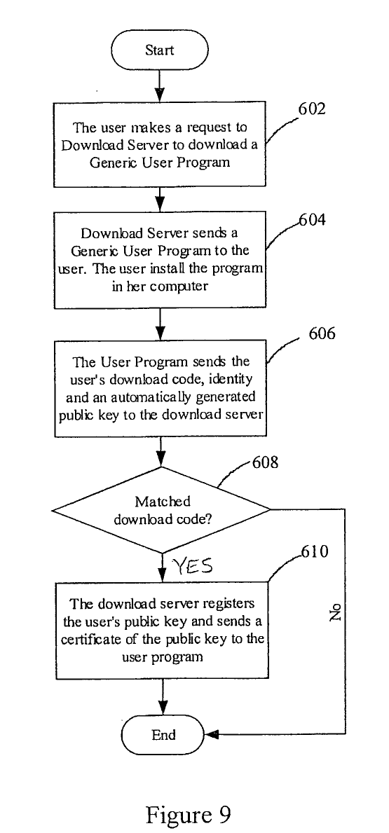

FIG. 9 is a flowchart showing a process for the user to obtain a generic user program using the download code according to the scheme of FIG. 7. Initially, the user makes a request to the download server 22 to download a generic user program as shown in step 602. The download server 22 then sends the generic user program to the user (step 604). The user installs the generic user program in his or her computer (step 604). Thereafter, the generic user program sends the user's download code and an automatically generated public key to the download server 22 (step 606). In the meantime, the user's identity can also be sent to the download server 22. The download server checks whether the download code that was submitted to the download server 22 matches the download code that the download server 22 pre-agreed with the download code authority 24 (step 608). If the two download codes match, the download server 22 registers the user's public key and sends a certificate of the public key to the user program (step 610). Otherwise, the download server 22 does not register the user's public key and does not send a certificate of the public key to the user program

In the scheme described in connection with FIG. 7, the system can have multiple pre-agreed user-specific download codes. The user can download the codes and install the program in multiple client systems, with different PKI keys used in different systems.

The download server can perform the same duty of a CA in the PKI system to handle the revocation and renewal of the public key of the user program. It is to be understood that the download code authority 24 and download server 22 as shown in FIG. 7 and the servicing server 11 as shown in FIG. 1 can be owned by the same entity or by different entities, depending on the security requirements and arrangements.

In various embodiments, the first and second schemes described hereinbefore in connection with FIGS. 4 and 7 can be used for an organization to offer its program to its users, so that the program can use PKI capabilities with automatic installation. A difference between the first scheme and the second scheme is with respect to key exchange. Using the first scheme, the key pair of private key and public key is embedded in the user program which is unique to each user. Using the second scheme, the key pair of private key and public key is generated when the user program is installed at the client side, and the public key is then submitted to the server side. Due to the difference in key exchange, the procedures for setting up the client and the interaction between the client and the server are different.

In one embodiment, the first and second schemes described hereinbefore in connection with FIGS. 4 and 7 can be used to combat the second challenge described in the Background Section on the user friendliness of acquiring and setting up the PKI keys.

Although the present invention has been described with reference to preferred embodiments, workers skilled in the art will recognize that changes may be made in form and detail without departing from the spirit and scope of the invention. In addition, the invention is not to be taken as limited to all of the details thereof as modifications and variations thereof may be made without departing from the spirit or scope of the invention.

We claim:

1. A method of authenticating a client when the client logs in a servicing server, the method comprising:
(A) submitting a first authentication code and a second authentication code from the client to the servicing server, the second authentication code including a secure token of a reversal secure token chain with a hash function and an index of the secure token in the reversal secure token chain;
(B) verifying the first authentication code at the servicing server;
(C) validating the secure token at the servicing server by comparing a hash value of the secure token with at least one of a previously acquired secure token or a root of the reversal secure token chain; and
(D) confirming the login if the first authentication code and the second authentication code are associated.

2. The method of claim 1 wherein the first authentication code comprises a password or a pair of login name and password.

3. The method of claim 1 further comprising a relationship setup prior to the step (A), wherein the relationship setup includes acquiring a server certificate and a client certificate, and wherein the relationship setup is conducted once or until one of the client and server certificates is expired or revoked.

4. The method of claim 3 wherein the client certificate comprises a name of the servicing server, a name of the client, a public key of the client and an expiration date of the client certificate, and wherein the client certificate is signed by a private key of the servicing server.

5. The method of claim 4 wherein the client certificate comprises contact information of the client.

6. The method of claim 3 further comprising a chain setup prior to the step (A), wherein the chain setup comprises:
(a) creating the reversal secure token chain with the hash function;
(b) creating a commitment;
(c) submitting the commitment to the servicing server; and
(d) verifying the commitment with a public key of the client at the servicing server; and
wherein the chain setup is conducted every time a new reversal secure token chain is created at the client.

7. The method of claim 6 wherein the reversal secure token chain and the commitment is created by a user program at the client.

8. The method of claim 7 wherein the user program at the client is downloaded from a download server.

9. The method of claim 8 wherein downloading the user program comprises the steps of:
(a) obtaining a user-specific download code;
(b) making a download request to the download server;
(c) submitting the user-specific download code to the download server;
(d) at the download server, checking whether the user-specific download code matches with a pre-agreed download code that the download server agreed with the download code authority;
(e) receiving the user program from the download server if the user-specific download code matches with the pre-agreed download code; and
(f) installing the user program at the client; and
wherein the user program is preloaded with PKI keys.

10. The method of claim 8 wherein downloading the user program comprises the steps of:
(a) obtaining a user-specific download code;
(b) making a download request to the download server;
(c) receiving the user program from the download server;
(d) installing the user program at the client;
(e) sending the user-specific download code and a public key from the user program to the download server;
(f) at the download server, checking whether the user-specific download code matches with a pre-agreed download code that the download server agreed with the download code authority; and
(g) registering the public key and sending a certificate of the public key to the user program; and
wherein the user program is a generic user program.

11. The method of claim 6 wherein the commitment comprises a purpose of the reversal secure token chain, the client certificate, the root of the reversal secure token chain and current date, and wherein the commitment is signed by a private of the client.

12. The method of claim 11 wherein the commitment comprises a period of time that the reversal secure token chain must be consumed.

13. The method of claim 1 wherein the secure tokes of the reversal secure token chain are consumed in an ascending order.

14. The method of claim 1 wherein the step (C) comprises comparing the hash value of the secure token with a last acquired secure token if the index of the secure token is greater than one.

15. The method of claim 1 wherein the step (C) comprises comparing the hash value of the secure token with the root of the reversal secure token chain if the index of the secure token is equal to one.

16. A method of authenticating a client when the client logs in a servicing server, the method comprising:
(A) submitting a secure token of a reversal secure token chain with a hash function and an index of the secure token in the reversal secure token chain from the client to the servicing server;
(B) validating the secure token at the servicing server by comparing a hash value of the secure token with at least one of a previously acquired secure token or a root of the reversal secure token chain.

17. The method of claim 16 further comprising:
(a) submitting a password or a pair of login name and password from the client to the servicing server; and
(b) verifying the password or the pair of login name and password at the servicing server.

18. The method of claim 16 wherein the step (B) comprises comparing the hash value of the secure token with a last acquired secure token if the index of the secure token is greater than one.

19. The method of claim 16 wherein the step (B) comprises comparing the hash value of the secure token with the root of the reversal secure token chain if the index of the secure token is equal to one.

20. A system of authenticating a client when the client logs in a servicing server, the system comprising:
(A) means for submitting a first authentication code and a second authentication code from the client to the servicing server, the second authentication code including a secure token of a reversal secure token chain with a hash function and an index of the secure token in the reversal secure token chain;
(B) means for verifying the first authentication code at the servicing server;
(C) means for validating the secure token at the servicing server by comparing a hash value of the secure token with at least one of a previously acquired secure token or a root of the reversal secure token chain; and
(D) means for confirming the login if the first authentication code and the second authentication code are associated.
